(19) United States
(12) Patent Application Publication
(10) Pub. No.: US 2026/0307585 A1
(43) Pub. Date: Oct. 8, 2026

(54) VEHICLE, CAP LAMP SYSTEM AND METHODS FOR COLLISION AVOIDANCE

(71) Applicants: SANDVIK MINING AND CONSTRUCTION OY, Tampere (FI); NEWTRAX TECHNOLOGIES, INC., Montreal (CA)

(72) Inventors: Martin BOUCHARD, Montreal (CA); William HOWARD, Montreal (CA); Alexandre CERVINKA, Tampere (FI); William-Alexis BOUCHARD, Montreal (CA)

(21) Appl. No.: 19/480,900

(22) PCT Filed: Jul. 3, 2024
(86) PCT No.: PCT/IB2024/056492

§ 371 Date: Nov. 3, 2025

Related U.S. Application Data
(60) Provisional application No. 63/464,040, filed on May 4, 2023.

(51) Int. Cl. B60Q 9/00; B60W 50/00; B60W 50/14; F21V 33/00

(52) U.S. Cl. CPC B60Q 9/008; B60W 50/0098; B60W 50/14; F21V 33/0076; B60Q 2800/20; B60Q 2900/30; B60W 2050/0005; B60W 2050/146

(57) ABSTRACT

A vehicle includes a first sensor to sense a first beacon emitted by a first beacon-emitting device worn by a person. The vehicle includes a collision-avoidance processor that determines if the person is located in an unsafe location relative to the vehicle based on a first signal generated by the first sensor. The collision-avoidance processor controls the vehicle in response to determining that the person is located in the unsafe location. A second beacon-emitting device near a seat in the vehicle emits a second beacon detectable by a second sensor worn by the person when the person sits in the seat. The second beacon has lower power and less range than the first beacon. The second sensor generates a second sensor signal in response to sensing the second beacon when the person sits in the seat, the first beacon-emitting device being deactivated in response to the second sensor signal.

### CROSS-REFERENCE TO RELATED APPLICATIONS

This application claims priority from U.S. Provisional Patent Application No. 63/464,040; filed on May 4, 2023, at the United States Patent and Trademark Office; and entitled “Vehicle Occupant Exclusion”; the entire content of which is hereby incorporated by reference.

### TECHNICAL FIELD

The present disclosure relates generally to systems and methods for mining vehicles to avoid collisions with pedestrians.

### BACKGROUND

Vehicle collision avoidance systems may be used in the mining industry to enable vehicles to detect and avoid other vehicles, pedestrians, and obstacles. Surface mines and underground mines are challenging environments for operating mining vehicles. Particularly in underground mines, visibility may be poor due to factors such as limited lighting and dust. Collision detection and avoidance systems enable increased safety in the operation of the vehicles and reduces the risk of collisions with pedestrians and obstacles. Some of these collision detection and avoidance systems include personal devices worn by pedestrians to enable the vehicle to detect that the miner is in close proximity to the vehicle or in a potentially unsafe location relative to the vehicle or its intended path. Improvements to these vehicle collision systems are highly desirable to further enhance the safety of pedestrians operating close to mining vehicles.

### SUMMARY

In general, the specification discloses various embodiments relating to a vehicle, a cap lamp system, and related methods of collision avoidance. A cap lamp system interacts with a vehicle to enable the vehicle to detect a pedestrian who is outside the vehicle and potentially at risk of being hit by the vehicle. The cap lamp system is able to detect when the miner (or, more generally, a worker or person) is safely inside a vehicle. When the cap lamp system detects that the person is safely inside the vehicle, the cap lamp deactivates transmission of a beacon that would otherwise be sensed by a vehicle collision avoidance system of the vehicle. When the person leaves the vehicle, the cap lamp system reactivates transmission of the beacon, which is sensed by the vehicle collision avoidance system of the vehicle to thereby enable the vehicle to avoid a collision with the person now outside the vehicle.

One aspect of the disclosure relates to a vehicle comprising a first sensor configured to sense a first beacon emitted by a first beacon-emitting device worn by a person, the first sensor generating a first sensor signal in response to sensing the first beacon. The vehicle includes a collision-avoidance processor communicatively coupled to the first sensor and configured to receive the first sensor signal. The collision-avoidance processor is configured to determine if the person is located in an unsafe location relative to the vehicle based, at least in part, on the first signal, wherein the collision-avoidance processor is further configured to control the vehicle by slowing, stopping or steering the vehicle in response to determining that the person is located in the unsafe location. The vehicle further includes a second beacon-emitting device disposed in or near a seat in the vehicle, the second beacon-emitting device emitting a second beacon detectable by a second sensor worn by the person when the person sits in the seat. The second beacon has lower power and less range than the first beacon, the second sensor generating a second sensor signal in response to sensing the second beacon when the person sits in the seat, the first beacon-emitting device being deactivated in response to the second sensor signal.

Another aspect of the disclosure relates to a cap lamp system comprising a cap lamp configured to be worn on a head of a person, the cap lamp having a first beacon-emitting device configured to emit a first beacon that is detectable by a first sensor of a vehicle to enable a collision-avoidance processor of the vehicle to determine if the person is located in an unsafe location relative to the vehicle. The cap lamp system also includes a belt pack configured to be worn by the person, the belt pack having a second sensor that is configured to sense a second beacon emitted by a second beacon-emitting device in or near a seat of the vehicle, the second beacon having lower power and less range than the first beacon, wherein the first beacon-emitting device in the cap lamp is configured to be deactivated when the second sensor detects the second beacon thereby indicating that the person is sitting safely inside the vehicle.

Yet another aspect of the disclosure relates to a method, performed by a vehicle, comprising sensing a first beacon emitted by a first beacon-emitting device of a cap lamp worn on a head of a person, determining from the first beacon if the person is located in an unsafe location relative to the vehicle, emitting a second beacon by a second beacon-emitting device disposed in or near a seat of the vehicle that is detectable by a second sensor in a belt pack also worn by the person, indicating that the person is sitting inside the vehicle, wherein transmission of the first beacon is deactivated in response to detecting the second beacon by the second sensor.

Yet another aspect of the disclosure relates to a method, performed by a cap lamp system, comprising emitting a first beacon by a first beacon-emitting device of a cap lamp worn on a head of a person, the first beacon being detectable by a first sensor of a vehicle to enable the vehicle to determine if the person is located in an unsafe location relative to the vehicle, sensing, by a second sensor in a belt pack also worn by the person, a second beacon emitted by a second beacon-emitting device in or near a seat of the vehicle, indicating that the person is sitting inside the vehicle, and deactivating transmission of the first beacon in response to detecting the second beacon by the second sensor.

Yet another aspect of the disclosure relates to a method comprising emitting a first beacon by a first beacon-emitting device worn by a person, the first beacon being detectable by a first sensor of a vehicle to enable the vehicle to determine if the person is located in an unsafe location relative to the vehicle, detecting by a second sensor that the person is seated in the vehicle, and deactivating transmission of the first beacon in response to detecting that the person is seated in the vehicle.

This summary is not an extensive overview of all contemplated embodiments and is not intended to identify key or critical aspects or features of any embodiments or to delineate any embodiments. Other aspects and features will become apparent to those of ordinary skill in the art upon review of the following description in view of the accompanying figures.

### BRIEF DESCRIPTION OF THE DRAWINGS

Example embodiments will be described in more detail referring to the following figures, in which:

FIG. 1 is a schematic block diagram of a mining vehicle collision avoidance system in accordance with an embodiment;

FIG. 2 depicts a mining vehicle having a vehicle collision avoidance system and further depicts a miner as a pedestrian wearing a cap lamp system that is detectable by the vehicle collision avoidance system in accordance with one embodiment;

FIG. 3 schematically depicts a mining vehicle having tags and leaky feeder antennas in accordance with another embodiment;

FIG. 4 depicts a cap lamp system in accordance with an embodiment;

FIG. 5 is a schematic block diagram of the cap lamp system of FIG. 4;

FIG. 6 is a flowchart depicting a method in accordance with one embodiment;

FIG. 7 is a flowchart depicting another method in accordance with another embodiment;

FIG. 8 is a flowchart depicting a further method in accordance with one embodiment;

FIG. 9A is a schematic depiction of an operator of a vehicle entering a cabin of the vehicle;

FIG. 9B is a schematic depiction of the operator of the vehicle checking into the cabin of the vehicle;

FIG. 9C is a schematic depiction of the operator of the vehicle exiting from the cabin of the vehicle;

FIG. 10A depicts a user interface of a belt pack of a cap lamp system enabling an operator to accept association with a vehicle;

FIG. 10B depicts the user interface confirming that the operator has been associated with the vehicle;

FIG. 10C depicts a user interface of a belt pack of a cap lamp system enabling a passenger to accept association with a vehicle;

FIG. 10D depicts the user interface confirming that the passenger has been associated with the vehicle;

FIG. 10E depicts a user interface of a belt pack of a cap lamp system enabling a person (operator or passenger) to reject association with a vehicle;

FIG. 10F depicts the user interface displaying a proximity warning that the person is too close to another vehicle and showing that the association has been cancelled;

FIG. 10G depicts the user interface showing that the vehicle association has been rejected by the operator or passenger; and

FIG. 10H depicts a main screen displayed on the user interface presenting the miner's name, a time of day, battery status and status of various wireless subsystems of the cap lamp system.

It will be noted that throughout the appended figures, like features are identified by like reference numerals.

### DETAILED DESCRIPTION

Disclosed herein are embodiments relating to a vehicle, a cap lamp system, and related methods of collision avoidance. By way of introduction and overview, a cap lamp system worn by a miner emits a beacon that a vehicle detects to enable the vehicle to sense that the miner (or, more generally, a worker, a person, or a pedestrian) is outside the vehicle and thus potentially at risk of being hit by the vehicle. When the cap lamp system detects that the person is safely inside the vehicle, the cap lamp deactivates transmission of the beacon that would otherwise be sensed by a vehicle collision avoidance system of the vehicle. When the person leaves the vehicle, the cap lamp system reactivates transmission of the beacon, which is sensed by the vehicle collision avoidance system of the vehicle to thereby enable the vehicle to avoid a collision with the person outside the vehicle.

In some embodiments, a vehicle has a first sensor configured to sense a first beacon emitted by a first beacon-emitting device worn by a person. The first sensor generates a first sensor signal in response to sensing the first beacon. The vehicle includes a collision-avoidance processor (also known as vehicle collision avoidance system or VCAS) which is communicatively coupled to the first sensor and configured to receive the first sensor signal. The collision-avoidance processor is configured to determine if the person is located in an unsafe location relative to the vehicle based, at least in part, on the first signal, wherein the collision-avoidance processor is further configured to control the vehicle by slowing, stopping or steering the vehicle in response to determining that the person is located in the unsafe location. The vehicle also includes a second beacon-emitting device disposed in or near a seat in the vehicle, the second beacon-emitting device emitting a second beacon detectable by a second sensor worn by the person when the person sits in the seat. The second beacon has lower power and less range than the first beacon, the second sensor generating a second sensor signal in response to sensing the second beacon when the person sits in the seat. The first beacon-emitting device is deactivated in response to the second sensor signal. In some embodiments, the first beacon-emitting device is part of a cap lamp system. In some specific implementations, the first beacon-emitting device is part of a cap lamp configured to be worn by the person. In some embodiments, the first sensor is mounted, connected, embedded or disposed on an external surface of the vehicle. In a variant, the first sensor may be disposed inside the vehicle or within an internal structure. The first sensor may have an antenna on a surface of the vehicle or extending above a surface of the vehicle while the remainder of the sensor is disposed inside the vehicle.

In some embodiments, the second beacon-emitting device is a proximity tag, and the second sensor is part of a belt pack configured to be worn by the person, the belt pack being part of the cap lamp system. In one specific implementation, the proximity tag is a Bluetooth® Low Energy (BLE) tag. Proximity sensing may be implemented using other low-power short-range wireless technologies such as, for example, near-field communication (NFC), ZigBee, or Wi-Fi. In a variant, the vehicle may include different types of tags. A customized RF emitter (that does not use a standard protocol) may also be used. Although RF detection is used in these embodiments, further sensors may be used to confirm that the passenger is indeed sitting in a given seat, e.g., a weight sensor in the seat, a magnetic sensor on or near the seat to detect a magnetic component installed in the belt pack, a thermal sensor to detect body heat of a passenger sitting in the seat. Such sensors can be used to confirm the initial RF-based proximity detection.

In another embodiment, the vehicle comprises a plurality of seats and a plurality of tags, e.g., BLE tags. For example, each seat may have a respective tag, e.g., BLE tag. In another embodiment, the vehicle may have a plurality of tags, e.g., BLE tags, for each seat. Tags may be installed at belt pack height or in any other suitable position relative to the seat, e.g., on or in a wall panel, inside or under the seat, on the floor, on the ceiling, on an armrest, on a seatbelt, etc.

In another embodiment, the vehicle comprises a plurality of seats and a common leaky feeder antenna. The leaky feeder antenna may be or include a radiating cable, e.g., a coaxial cable having gaps or slots along its length that leak RF emissions. The leaky feeder antenna may operate in a UHF or VHF band. In a variant, there may be multiple leaky feeder antennas. For example, a first leaky feeder antenna may cover a first group of seats whereas a second leaky feeder antenna may cover a second group of seats. The first group of seats may for example be on a first side (e.g., left side) of the vehicle whereas the second group of seats may be for example on a second side (e.g., right side) of the vehicle. For example, the vehicle may have multiple benches and have one leaky feeder antenna per bench. In a variant, the vehicle may use any combination of one or more tags and one or more leaky feeder antennas.

In one embodiment, the collision-avoidance processor is configured to receive a confirmation signal generated by the belt pack in response to user input from the person confirming that the person is inside the vehicle. The confirmation signal may be generated in response to user input. User input may be provided via the cap lamp system, e.g., via a user interface of a belt pack of the cap lamp system. This will be described in greater detail below.

In one embodiment, the collision-avoidance processor (vehicle collision avoidance system) is configured to detect a door switch state and a safety belt state to validate an initial determination that the person is inside or outside the vehicle. The door switch state can be used in conjunction with the RF-based proximity detection to more accurately infer the presence of passengers inside or outside the vehicle. Likewise, the safety belt state can be used in conjunction with the RF-based proximity detection to more accurately infer if the passenger is seated or not. Vehicle speed may also be used to infer passenger movement into and out of the vehicle. If the vehicle speed is reduced to zero (vehicle becomes stationary) and/or the door opens, the collision-avoidance processor can infer that one or more passengers are going to enter or exit the vehicle. If seat belts are detached, then the doors open, it may be inferred that passengers are disembarking. If the door opens and then seat belts are attached, it may be inferred that passengers have boarded the vehicle. Weight sensors in the seats and/or floor and/or elsewhere in the vehicle may be used to infer if passengers have boarded or disembarked.

In one embodiment, the collision-avoidance processor (vehicle collision avoidance system) is configured to detect a fault state or a low battery state in the tag, e.g., BLE tag. In a variant, the collision-avoidance processor is configured to detect both the fault state and the low battery state. Check-in may optionally be blocked for a particular seat in the event of a low battery state or a fault state. A message may be displayed on the user interface of the cap lamp system that there is a low battery state or a fault state precluding check-in in that particular seat.

In one embodiment, the collision-avoidance processor is configured to detect if the tag, e.g., BLE tag, has been disconnected. The collision-avoidance processor, in one specific implementation, can be configured to generate and send an alert, a notification and/or a warning that the tag, e.g., BLE tag, has been disconnected. Again, check-in may optionally be blocked for a particular seat in the event of a disconnected tag, e.g., BLE tag. A message may be displayed on the user interface of the cap lamp system that there is a disconnected tag, e.g., BLE tag, precluding check-in in that particular seat.

In other embodiments, a cap lamp system comprises a cap lamp configured to be worn by a person, e.g., a miner, a worker, etc. The cap lamp in this embodiment has a first beacon-emitting device configured to emit a first beacon that is detectable by a first sensor of a vehicle to enable a collision-avoidance processor of the vehicle to determine if the person is located in an unsafe location relative to the vehicle. The cap lamp system in this embodiment includes a belt pack also configured to be worn by the person, the belt pack having a second sensor that is configured to sense a second beacon emitted by a second beacon-emitting device located in or near a seat of the vehicle. The second beacon may have lower power and less range than the first beacon. In one embodiment, the second beacon-emitting device is a Bluetooth® Low Energy (BLE) tag. The first beacon-emitting device in the cap lamp is configured to be deactivated when the second sensor detects the second beacon thereby indicating that the person is sitting safely inside the vehicle. In some embodiments, the first beacon-emitting device only resumes emitting the first beacon when the second beacon is no longer detected by the second sensor. This occurs, for example, when the received signal strength indicator (RSSI) of the second beacon drops below a predetermined RSSI threshold. This predetermined RSSI threshold optionally can be calibrated or adjusted to correspond with a distance to the door or to a point outside the vehicle so that the beacon only resumes emitting when the person has left the vehicle. The predetermined RSSI threshold may optionally be adjustable or reconfigurable by the cap lamp system, e.g., using a calibration or adjustment setting or menu accessible via, for example, a user interface of the cap lamp system. Alternatively, the cap lamp system may optionally store a plurality of different vehicle-specific RSSI thresholds. In other words, the cap lamp system may store a first predetermined RSSI threshold for a first type of vehicle (e.g., a heavy vehicle) and a second predetermined RSSI threshold for a second type of vehicle (e.g., a light vehicle).

In one embodiment, the belt pack comprises a user interface to display an automatically determined status of the person, the status indicating whether the person is considered to be inside the vehicle or outside the vehicle. In one embodiment, the user interface comprises a user input device to enable the person to manually confirm the automatically determined status. In one embodiment, the user interface comprises a user input device to enable the person to manually identify the person as an operator of the vehicle or as a passenger of the vehicle. Specific example implementations and additional details are provided below.

In one embodiment, the second beacon-emitting device broadcasts an identifier code identifying the seat as being either an operator seat or a passenger seat. The identifier code can be used to validate or authenticate the person as an authorized operator of the vehicle or merely a passenger of the vehicle. In a variant, the identifier code may be transmitted from a separate code-transmitting device in the cap lamp system.

In one embodiment, one or both of the belt pack or cap lamp comprises a light that turns on, blinks or changes colour when the status of the person is automatically determined or when the person manually confirms the status.

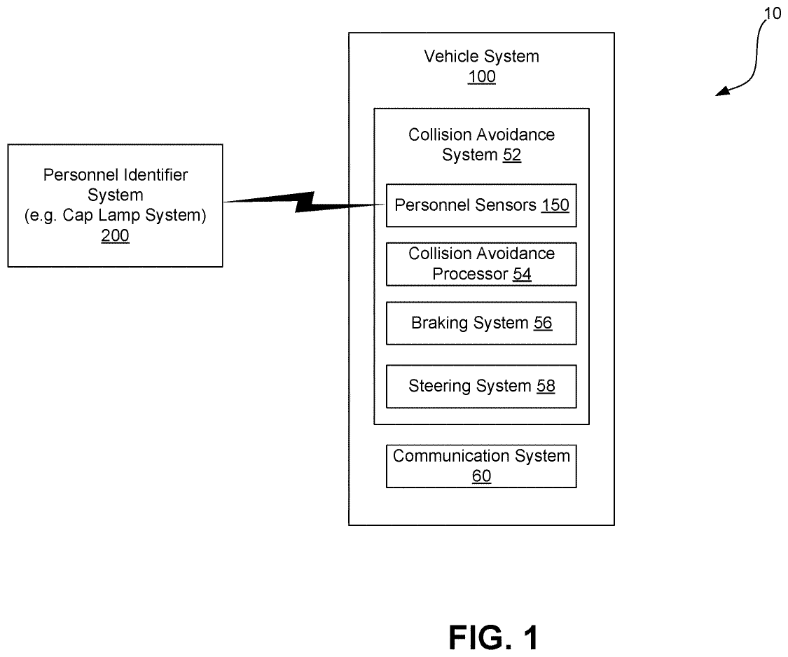

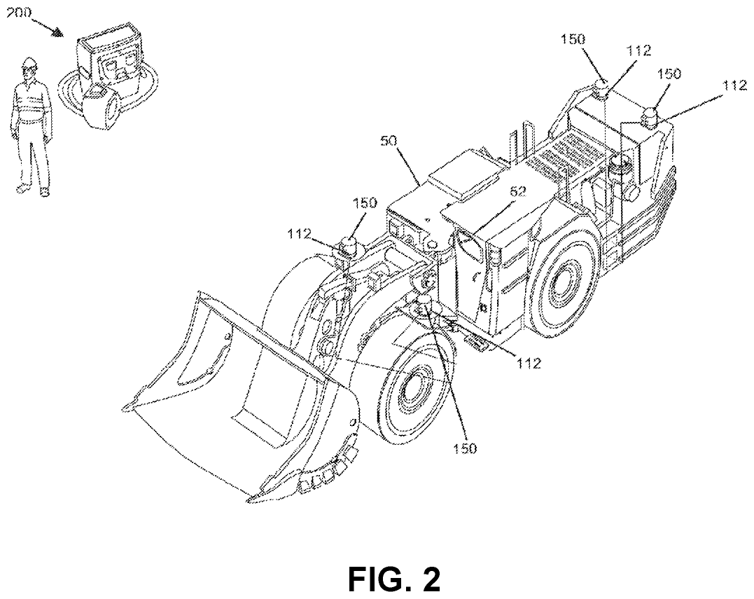

FIG. 1 schematically depicts a mining vehicle collision avoidance system 10 for avoiding collision with a miner wearing a cap lamp system in accordance with an example embodiment. As depicted by way of example in FIG. 1, the system 10 may include a vehicle system 100, for example, a mining vehicle system 100, a cap lamp system 200 (e.g., cap lamp system) for broadcasting or transmitting a beacon or identification of the cap lamp system 200. The vehicle system 100 may be a standalone system installed in a vehicle, or it may be partly or fully integrated in a vehicle such as a mining vehicle 50 as shown by way of example in FIG. 2. The cap lamp system 200 may be a standalone system to be carried or worn by a person, or it may be partly or fully integrated with another device such as a cap lamp device or smart clothing.

As depicted by way of example in FIG. 1, the vehicle system 100 includes a collision avoidance system (CAS) 52, also referred to herein as a vehicle collision avoidance system (VCAS) configured to avoid collisions with other vehicles, equipment, obstacles (e.g., mine walls) and with personnel (i.e., miners, workers, or other persons). The collision avoidance system 52 includes one or more proximity detection sensors (or beacon sensors) 150. The collision avoidance system 52 further includes a collision avoidance processor 54 that processes signals received from the proximity detection sensors 150 to avoid any personnel in an unsafe location outside the vehicle. The collision avoidance processor 54 interacts and cooperates with a braking system 56 and/or a steering system 58 to avoid collisions with personnel based on the signals received by the proximity detection sensors 150. In other words, the collision avoidance processor 54 processes the signals received by the proximity detection sensors 150 and, if the collision avoidance processor 54 determines that a person is in an unsafe location relative to the vehicle (i.e. is at risk of being hit by the vehicle), the collision avoidance processor 54 generates and sends a brake signal to the brake system 56 and/or a steering signal to the steering system 58 to control the vehicle to minimize any risk of collision with the person. If the collision avoidance processor 54 sends a brake signal and/or a steering signal to avoid a pedestrian, a report of the incident (collision avoidance event) may be generated.

The vehicle 50 may be operated in a mine, such as an aboveground mine, underground mine, or any other environment such as a parking lot or maintenance area. As described in greater detail below, the vehicle system 100, in particular, one or more proximity detection sensors 150 (or beacon sensors 150) of the vehicle system 100, determines a proximity of a cap lamp system 200, for example, the presence or absence of the cap lamp system 200, or the distance between the one or more proximity detection sensors 150 and the cap lamp system 200. If the proximity of the person wearing the cap lamp system 200 is within a predetermined distance of the vehicle, the collision avoidance processor 54 of the vehicle considers the person to be in unsafe location relative to the vehicle. The predetermined distance may be a variable distance based on the speed of the vehicle, the type of vehicle, the type of braking system, the type of steering system, the weight of the vehicle, the nature of environment, visibility and/or other factors. In another implementation, the collision avoidance processor 54 may be configured to control any other equipment, machinery or subsystem of the vehicle including a rock drill, rock bolter, shovel, front-end loader, etc. to prevent collision with a pedestrian outside the vehicle. The collision avoidance processor 54 may be configured to send a stop movement command to a hydraulic controller of any equipment, machinery or subsystem of the vehicle to immediately stop movement or operation of such equipment, machinery or subsystem that may pose a risk to a nearby pedestrian.

FIG. 2 depicts the mining vehicle collision avoidance system 10 in accordance with one embodiment. As depicted by way of example in FIG. 2, the system 10 includes a vehicle system 100 that may be installed or integrated in a vehicle 50, such as a mining vehicle 50. As depicted by way of example in FIG. 2, the vehicle 50 is a loader having four wheels, a front scoop and a rear-mounted engine. The vehicle 50 could be any other mining vehicle, such as a utility vehicle, personnel transport, wagon, rescue vehicle, haul truck, scaler, grader, rock breaker, road header, and the like. For example, the vehicle could have tracks, run on rails, or have any other mechanism for motion. The vehicle can be autonomous, semi-autonomous or human driven. The vehicle may be remotely controlled, e.g., radio controlled, for operation at a distance. The vehicle could have an electric motor, an internal combustion engine, hydrogen fuel cell or any other form of propulsion.

In the example depicted in FIG. 2, the vehicle has one or more proximity detection sensors 150 (beacon sensors) disposed on the vehicle 50. In the particular example presented in FIG. 2, the vehicle has four proximity detection sensors 150, one on the front left side of the vehicle 50, one on the front right side of the vehicle 50, one on the rear left side of the vehicle 50, one on the rear right side of the vehicle 50. In the example of FIG. 2, the one or more proximity detection sensors 150 are disposed about the periphery or outer portions of the vehicle 50, such that proximity of a cap lamp system 200 may be detected before the vehicle 50 collides with the person wearing the cap lamp system 200. As further illustrated in FIG. 2, the vehicle has one or more lights 112. In the example depicted in FIG. 2, the vehicle has four lights 112 (lighting subsystems 112). In this particular example, there is one lighting subsystem 112 associated with each of the proximity detection sensors 150. In the example shown in FIG. 2, the lighting subsystems 112 are co-located with the proximity detection sensors 150. In other variants, the number of lighting subsystems 112 is not equal to the number of proximity detection sensors 150. In other variants, the lighting subsystems 112 may be placed elsewhere (i.e., they are not co-located with the proximity detection sensors 150 as shown in FIG. 2). If the vehicle collision avoidance processor 54 detects a miner in proximity or in an unsafe location relative to the vehicle or its intended path, the vehicle collision avoidance processor 54 may send signals to the steering system 58 and/or braking system 56 to steer and/or brake the vehicle to avoid collision with the miner. If the vehicle collision avoidance processor 54 detects a miner in proximity or in an unsafe location relative to the vehicle, the vehicle collision avoidance processor 54 may cause the lights 112 to illuminate, blink or flash.

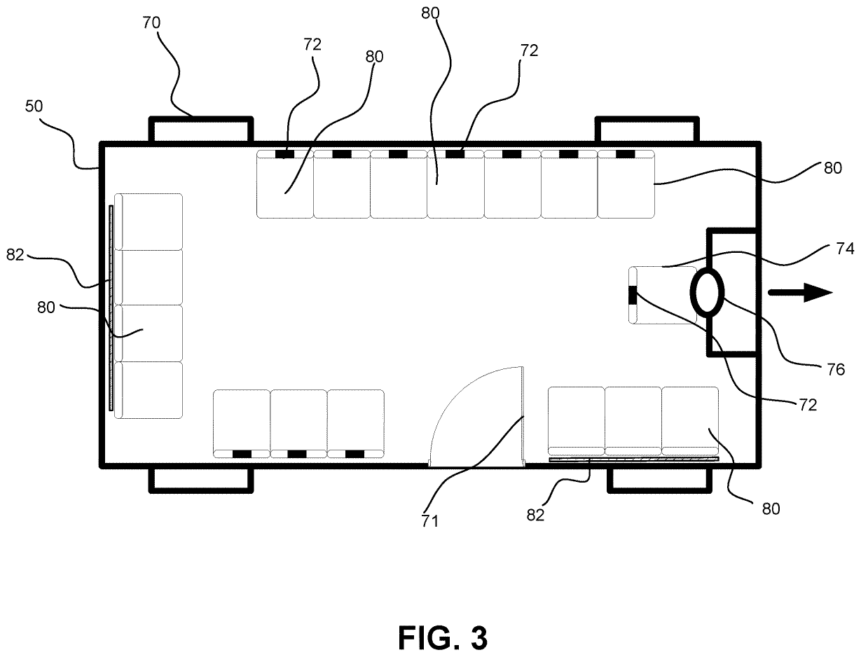

FIG. 3 is a schematic depiction of an example vehicle 50 having a plurality of seats, which may be arranged alone or in groups or rows. The arrangement of seats is exemplary, and it will be appreciated that any other arrangement of seats may be used. Seats may be grouped together in rows. Alternatively, a bench may be installed instead of a row of seats. For example, the vehicle 50 may have a plurality of wheels 70 and a door 71 (with an optional door sensor), an operator seat 74 and a steering wheel 76 for the operator. The vehicle 50 includes in this example a proximity tag, e.g., a BLE tag, 72 associated with the operator seat 74. The vehicle has a plurality of passenger seats 80. In some embodiments, as shown in FIG. 3, a proximity tag, e.g., BLE tag 72, is disposed in, on, or near each respective seat so as to sense when a person is sitting in the seat. In other words, the proximity tag may be embedded in a seat, placed on a surface of the seat or mounted to another structure beside or adjacent to the seat so that a sensor of the cap lamp system can sense the tag when the person is sitting on the seat. Generally, if there are multiple seats beside each other or clustered together, each respective proximity tag must be closer to a center of its respective seat than to the center of the next closest seat. In one implementation, the proximity tag is considered to be “near” the seat if it is no more than 100 cm from the center of the seat. In another implementation, the proximity tag is considered to be “near” the seat if it is no more than 50 cm from the center of the seat. In yet another implementation, the proximity tag is considered to be “near” the seat if it is no more than 10 cm from the center of the seat.

As further depicted by way of example in FIG. 3, the vehicle may have a leaky feeder antenna 82. There may be multiple leaky feeder antennas 82 for different rows or groups of seats as shown by way of example.

In another embodiment, there may be multiple tags per seat. In this embodiment, the sensor 208 may be configured to send two detection signals to the processor 202. In one implementation, the processor 202 may be configured to send the one or more control signals to the beacon-emitting device 203 only if two (i.e., both) detection signals are received.

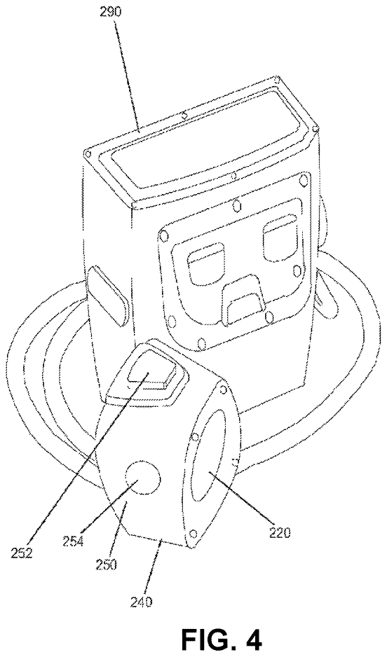

FIG. 4 is a schematic depiction of a cap lamp system denoted generally by reference numeral 200. The cap lamp system 200 includes a cap lamp 240 mounted or mountable to a helmet configured to be worn on a head of a user, and a belt pack 290 wearable around the waist of the user. The cap lamp may be installed on, or integrated in, a helmet or other headpiece. The first beacon-emitting device may be incorporated into the cap and/or into the lamp mounted to the cap. In the example shown in FIG. 4, the cap lamp 240 includes a housing 250, a lighting subsystem 220, and a switch or button 252 for variably activating the lighting subsystem 220 or to modulate the lighting subsystem 220 (e.g., blink, flash, etc.). For example, a user, a person, or an operator who is wearing the cap lamp system 200 may actuate the switch 252 to turn on or turn off the lighting subsystem 220. For example, the lighting subsystem 220 and the switch 252 are mountable to the housing 250. The cap lamp and belt pack may be connected to one another. For example, the cap lamp and belt pack may be connected by one or more cables or wires for data communication between the cap lamp and belt pack and for supplying power. In a variant, data communication between the cap lamp and belt pack may be wireless.

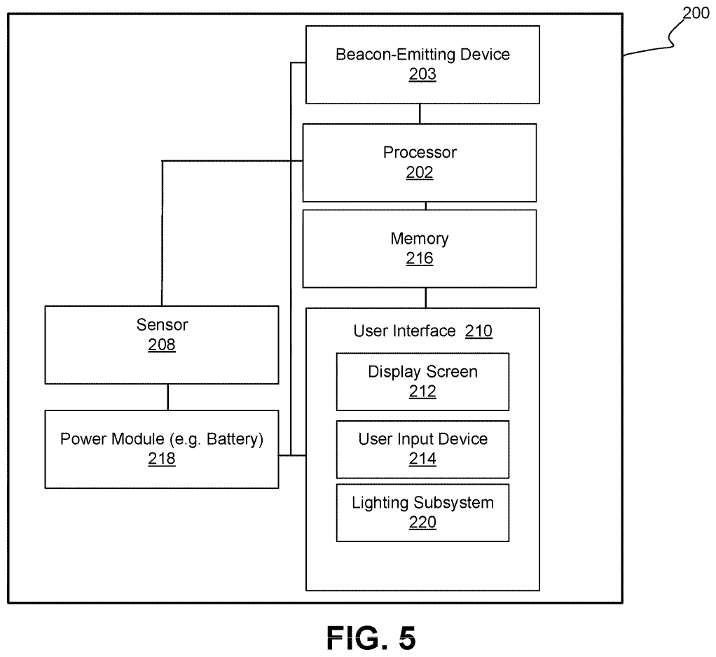

FIG. 5 schematically depicts, as a block diagram, example components of the cap lamp system 200 shown by way of example in FIG. 4. As depicted by way of example in FIG. 5, the cap lamp system 200 includes a processor 202 (i.e., microprocessor or other microcontroller or multiple microprocessors or microcontrollers), a beacon-emitting device 203 coupled to the processor, and a memory 216 coupled to the processor 202. The beacon-emitting device is configured to emit a beacon detectable by a vehicle. In specific embodiments, the beacon emitted by the beacon-emitting device 203 is detectable by the one or more proximity detection sensors 150 (beacon sensors) of the vehicle. The beacon-emitting device 203 may emit, for example, an Ultra Wideband beacon in a 5-6 GHz band to enable the beacon sensor 150 of the vehicle to sense the presence of the cap lamp system using e.g., UWB time-of-flight (ToF). The beacon may alternatively emit a Chirp Spread Spectrum (CSS) beacon in a 2.4 GHz band to enable the beacon sensor 150 of the vehicle to sense the presence of the cap lamp, e.g., using CSS ToF. As another example, the beacon may be in a 900 MHz band. In a variant, the cap lamp system may be able to emit multiple beacons, simultaneously or sequentially, or to switch between one type of beacon and another. In one or more embodiments, the processor 202 is connected to, and thus controls, the beacon-emitting device 203. The processor 202 may be configured to activate, deactivate, and reactivate the beacon-emitting device 203 by sending one or more control signals to the beacon-emitting device 203. The processor 202 is configured to deactivate the beacon-emitting device 203 when a person is safely inside the vehicle and to reactivate the beacon-emitting device 203 when the person exits the vehicle. In the example embodiment depicted in FIG. 5, the cap lamp system 200 includes a sensor 208, which is also coupled to the processor 202, for sensing a short-range beacon emitted by a proximity tag inside the vehicle such as a BLE tag. In some embodiments, the sensor 208 is part of the belt pack of the cap lamp system. When the sensor 208 senses the short-range beacon emitted by the proximity tag, e.g., BLE tag, the sensor 208 sends a signal to the processor that the person is inside the vehicle. Responsive to this signal, the processor 202 generates and sends the one or more control signals to the beacon-emitting device 203 to deactivate the beacon-emitting device 203 thereby causing the beacon-emitting device 203 to cease broadcasting. The vehicle thus no longer detects the person wearing the cap lamp system 200 because the beacon is no longer being broadcast. As such, the occupant of the vehicle is considered excluded from the vehicle collision avoidance system. When the person exits the vehicle, the sensor loses the signal from the proximity tag. The sensor 208 sends a loss-of-proximity signal to the processor. Responsive to this loss-of-proximity signal, the processor generates and sends one or more control signals to the beacon-emitting device to reactivate the beacon-emitting device thereby causing the beacon-emitting device to start broadcasting the beacon again. As such, the vehicle collision avoidance system resumes tracking the cap lamp system worn by the person. In some embodiments, the sensor 208 is configured to send the signal to the processor when a received signal strength indicator (RSSI) exceeds a threshold, e.g., a predetermined threshold. In other words, in some embodiments, a first beacon-emitting device in the cap lamp can be deactivated when the sensor 208 detects that the received signal strength indicator (RSSI) of a second beacon (short-range beacon of a proximity tag) exceeds a predetermined threshold. Similarly, in some embodiments, when the RSSI falls below the predetermined threshold, the sensor 208 sends the loss-of-proximity signal to the processor to cause the processor to reactivate the beacon-emitting device 203.

In the embodiment depicted by way of example in FIG. 5, the cap lamp system 200 includes a power module (e.g., a battery or multiple batteries) 218 connected to the various components shown in FIG. 5 in order to power these various components.

Optionally, the beacon-emitting device 203 may broadcast a unique identification or identifier, such as an alphanumeric 9-digit code or a MAC address. For example, the identification of the cap lamp system 200 may include or may be a bit string or a data structure associable with the cap lamp system 200, which may be associated with an operator's name, employee number, level of training, role, position, authority, level of authorization, and the like.

As depicted by way of example in FIG. 5, the cap lamp system 200 may have a user interface 210. The user interface 210 may optionally be disposed on the belt pack 290 as shown in the example of FIG. 4. The user interface 210 of cap lamp system 200 may, in some embodiments, have a display screen 212 and a user input device 214 which may include one or more buttons as shown for example in FIG. 4. The display screen 212 may be useful if the operator wants to confirm a presence inside or outside a vehicle, e.g., by pressing one or more buttons. In one embodiment, the display screen and user input device may be combined in a touch-sensitive display screen. In a variant, there may be multiple display screens. Alternatively, there may be a separate display that is separate and distinct from the belt pack. Alternatively, a mobile device such as a smart phone or tablet may be paired or connected to the cap lamp system and used as the display. As depicted by way of example in FIG. 5, the cap lamp system may include a lighting subsystem 220. The cap lamp includes a lamp. In addition to the lamp of the cap lamp, there may be lights that are part of a user interface to alert or notify the person wearing the cap lamp system of a status of the cap lamp system. The processor 202 may cooperate with the lighting subsystem 220 to display various coloured lights, to blink, to flash, etc. to provide various forms of alerts and notification to the user in addition to any information displayed on the display screen 212 of the user interface 210.

Optionally, the cap lamp system 200 may include one or more communication subsystems or modules such as, for example, an RFID or NFC tag, a Wi-Fi module, an RF module, a WWAN module, and/or a Bluetooth module.

In some embodiments, the processor 202 is configured to execute computer-readable instructions in code, i.e., machine-readable software code, to perform a method of excluding an occupant from being identified as a pedestrian by the vehicle collision avoidance system. In one such embodiment, the processor 202 cooperates with the memory 216 to execute computer-readable instructions in code to deactivate a first beacon-emitting device in response to the sensor 208 detecting a second beacon being emitted by a second beacon-emitting device, e.g., the BLE tag. Further computer-readable instructions in code may be stored in the memory 216 and executed by the processor 202 to perform various methods described above or to perform aspects or portions of these methods.

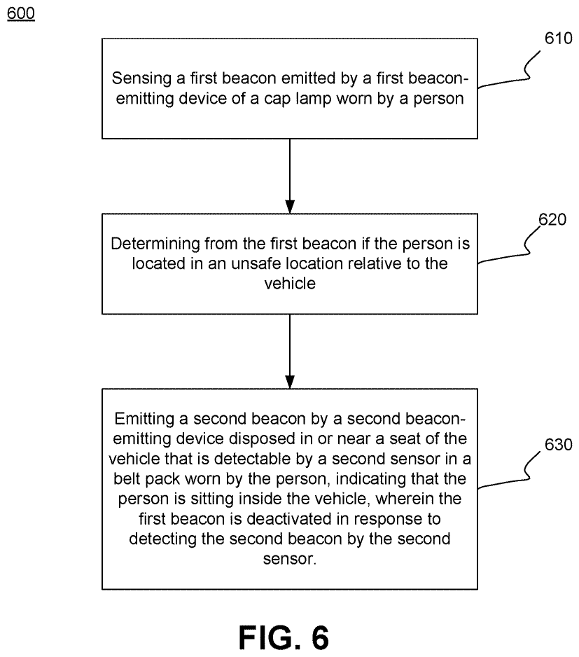

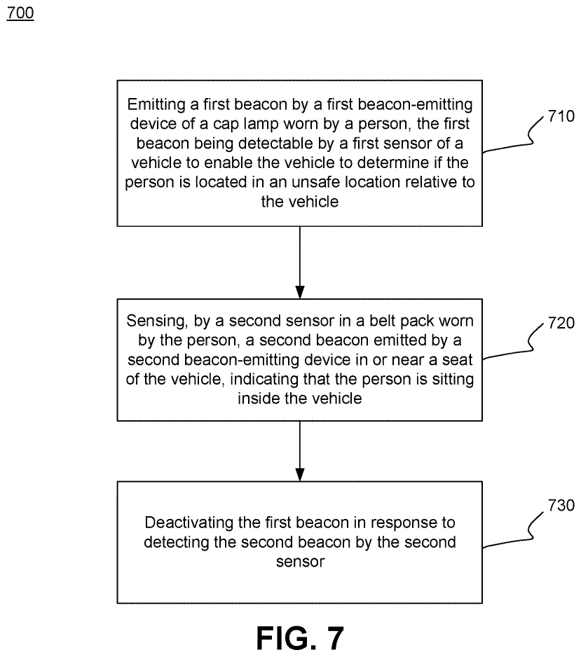

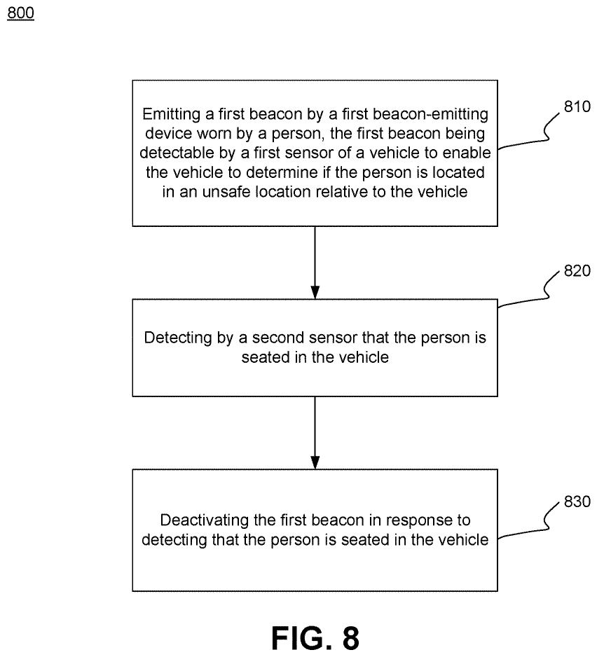

Another aspect relates to a method of excluding an occupant of a vehicle from being identified as a pedestrian by a vehicle collision avoidance system (VCAS). This method is outlined in a flowchart depicted in FIG. 6. The method 600, performed by a vehicle (e.g., by a VCAS processor of the vehicle), comprises steps, acts, or operations of sensing 610 a first beacon emitted by a first beacon-emitting device of a cap lamp worn by a person, determining 620 from the first beacon if the person is located in an unsafe location relative to the vehicle, and emitting 630 a second beacon by a second beacon-emitting device disposed in or near a seat of the vehicle that is detectable by a second sensor in a belt pack also worn by the person, indicating that the person is sitting inside the vehicle, wherein transmission of the first beacon is deactivated in response to detecting the second beacon by the second sensor.

In the method, the second beacon optionally has lower power and less range than the first beacon. Optionally, the second beacon-emitting device is a Bluetooth® Low Energy (BLE) tag. As noted above, other ways of RF proximity sensing may be used to detect that the miner is inside the vehicle.

The method may optionally entail displaying an automatically determined status of the person, the status indicating whether the person is considered to be inside the vehicle or outside the vehicle. The status may be displayed on a display screen of the belt pack of the cap lamp system.

The method may optionally involve receiving user input from the person to manually confirm the automatically determined status. The user input may be provided via a button or user input device disposed on the belt pack. Alternatively, user input may be provided by a voice command received via a microphone connected to the cap lamp system. For example, a miner helmet (to which the cap lamp may be mounted or otherwise incorporated) may include one or more earphones and a microphone to enable the miner to communicate wirelessly with other miners, workers, supervisors, etc. This microphone may be used to receive a voice command from the miner. Similarly, the check-in process and/or check-out process may entail audible confirmations delivered to the miner via the earphones.

The method may optionally involve receiving user input from the person to manually identify the person as an operator of the vehicle or as a passenger of the vehicle. This user input may be provided via a button or user input device disposed on the belt pack. Identification of the person may also be done using biometrics, facial recognition via a camera or by any other suitable technique.

The method may optionally involve detecting a door switch state and/or a safety belt state to validate an initial determination that the person is inside or outside the vehicle. In a variant, the method involves detecting only the door switch state. In another variant, the method involves only detecting the safety belt state.

Another aspect relates to a method 700, performed by a cap lamp system, comprising emitting 710 a first beacon by a first beacon-emitting device of a cap lamp worn by a person, the first beacon being detectable by a first sensor of a vehicle to enable the vehicle to determine if the person is located in an unsafe location relative to the vehicle, sensing 720, by a second sensor in a belt pack also worn by the person, a second beacon emitted by a second beacon-emitting device in or near a seat of the vehicle, indicating that the person is sitting inside the vehicle, and deactivating 730 transmission of the first beacon in response to detecting the second beacon by the second sensor.

The method may optionally comprise displaying on the belt pack an automatically determined status of the person, the status indicating whether the person is inside the vehicle or outside the vehicle. Further examples and details are provided below.

The method may optionally entail receiving user input from the person to manually confirm the automatically determined status. The method may optionally entail causing a light on one or both of the belt pack or cap lamp to turn on, blink or change colour when the status of the person is automatically determined to be inside the vehicle or when the person manually confirms the status.

Furthermore, the method may optionally entail receiving user input from the person to manually identify the person as an operator of the vehicle or as a passenger of the vehicle.

The method may optionally entail broadcasting by the cap lamp or belt pack an identifier code identifying the person as an operator or as a passenger. In such a case, the operator wears an operator-specific cap lamp system whereas a passenger would wear a passenger-specific cap lamp system.

Another aspect relates to a method 800 comprising emitting 810 a first beacon by a first beacon-emitting device worn by a person, the first beacon being detectable by a first sensor of a vehicle to enable the vehicle to determine if the person is located in an unsafe location relative to the vehicle, detecting 820 by a second sensor that the person is seated in the vehicle, and deactivating 830 transmission of the first beacon in response to detecting that the person is seated in the vehicle. In one embodiment, the second sensor detects a second beacon emitted by a second beacon-emitting device disposed in the vehicle. The second beacon-emitting device, in one implementation, is a Bluetooth® Low Energy (BLE) tag. In other implementations, the second beacon-emitting device may be another short-range low-energy device, tag, or emitter. Alternatively, the second beacon-emitting device can be a leaky feeder antenna. In a variant, there may be multiple leaky feeder antennas.

In one embodiment of the method, the second sensor is disposed in a belt pack worn by the person. In one embodiment of the method, the first beacon-emitting device is part of a cap lamp worn by the person. Accordingly, the method can be performed using a cap lamp system having a cap lamp and a belt pack.

Some of the embodiments described herein provide a vehicle occupant exclusion (VOE) feature that enables a mining vehicle to detect a miner who is wearing a cap lamp system and to identify the miner as currently being an occupant of the vehicle. Once the miner has entered inside the cabin of the mining vehicle, the vehicle excludes the miner (i.e., the occupant) from being identified as a pedestrian for as long as the miner remains safely inside the vehicle. A low-energy, short-range tag or beacon is detected by equipment worn by the miner to indicate that the miner is inside the vehicle. In one embodiment, the tag is a BLE tag emitting a BLE beacon, also referred to herein as a VOE BLE beacon. In one embodiment, the tag is under, inside or beside a seat or bench to enable the cap lamp system to detect that the miner is seated inside the vehicle. The cap lamp system deactivates its beacon to become effectively invisible to the vehicle collision avoidance system (VCAS) which has the effect of excluding the cap lamp system (and the miner wearing it) from being identified as a pedestrian. Deactivation of the cap lamp beacon in one example occurs in response to detecting a BLE beacon emitted from the BLE tag. Depending on how the BLE beacons are configured in the vehicle, after entering a vehicle, the vehicle occupant is either automatically associated with the vehicle or receives an association request via the belt pack of the cap lamp system. Once associated, e.g., by receiving a reply to the association request, a notification message can be displayed on a display screen of the belt pack. In one implementation, a main light (e.g., LED) on the cap lamp (or helmet or headpiece) may illuminate or flash once, twice, or multiple times, a belt pack light (e.g., an LED array around the belt pack) may turn a solid color, e.g., blue, and a corresponding VOE icon may be displayed on the belt pack display screen. In one variant, a coloured frame may be displayed around the display screen.

Upon exiting the vehicle, the cap lamp system disassociates from the BLE beacon emitted by the BLE tag, e.g., when the received signal strength indicator (RSSI) of the BLE beacon falls below a predetermined threshold. The cap lamp system will resume emitting its beacon (i.e., it will resume ranging with the VCAS of any nearby vehicle). To notify the pedestrian of a check-out, the cap lamp system may turn on a light (e.g., a main LED on the cap lamp, helmet, or headpiece). Alternatively, this light may flash once, twice, or multiple times, and the VOE icon is then no longer displayed on the belt pack. Optionally, the belt pack light (e.g., an LED array) is no longer lit up (e.g., no longer lit blue). A blue light may be used to signify occupant exclusion and the absence of such a light indicates that the pedestrian proximity warning is re-enabled. Any other lighting or colour scheme may be used.

In another implementation, automatic association can be used to automatically exclude the miner as an occupant of a vehicle. When a vehicle occupant is automatically associated, a notification message may be displayed on the screen of the belt pack corresponding to the type of vehicle occupant.

In one implementation, the occupant is no longer visible to any VCAS when the associated notification is shown. Upon pressing a selection button on the belt pack of the cap lamp system, the screen returns to a main display and the VOE Operator or Passenger Icon is displayed, e.g., next to the time and/or other information.

When confirmation is required for a vehicle occupant to be associated or checked-in, a notification message may be displayed on the screen of the belt pack corresponding to the type of vehicle occupant. The occupant confirms that he wants to be checked in by pressing on the appropriate button of the belt pack. The operator may also have an option to associate as a passenger (if applicable) by scrolling through the menu or to reject association by scrolling to the appropriate menu.

In this embodiment, only after confirming acceptance as an Operator or Passenger will the cap lamp system be associated and stop ranging with the VCAS. Once selecting “OK” on the confirmation screen, the belt pack will display the notification that the cap lamp system has been associated. Optionally, the main light (main LED) on the cap lamp (headpiece) will flash once, twice, or multiple times, the light (e.g., LED array) around the belt pack will be lit up (e.g., lit a solid blue). Optionally, a corresponding VOE icon will be present on the display.

In one implementation, if the vehicle occupant is too close to a VOE BLE tag from another vehicle and meets the VOE check-in criteria, the vehicle operator will be unable to associate to a VOE BLE tag. The occupant will not be able to associate and will see a message on the belt pack that shows “Vehicle Association Rejected” with an icon that shows VOE cancelled until the VOE BLE beacon from the other vehicle is no longer detected.

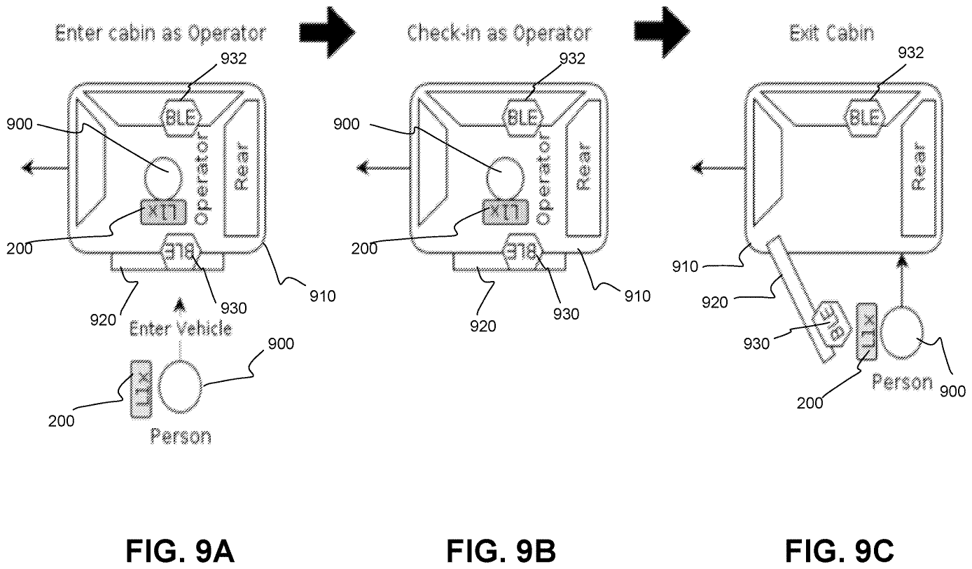

In a specific embodiment, the occupant may be the operator (driver) of the vehicle as opposed to a mere passenger. As depicted by way of example in FIGS. 9A-9C, the person (operator) 900 is wearing a cap lamp system 200 which is also denoted L1x in these figures. The person (operator) 900 enters a cabin 910 of the vehicle via a vehicle door 920 as shown in FIG. 9A. In this particular example, there are two BLE tags 930, 932 on each side of the operator seat. In this specific example, a first BLE tag 930 is disposed in (or on) the door 920 whereas a second BLE tag 932 is disposed in (or on) a right side wall or cabin structure of the vehicle. In a variant, there could be a third BLE tag. In other words, any suitable number of BLE tags may be used in various implementations. When the operator 900 is seated in the operator seat of the vehicle, the cap lamp system 200 detects one or both nearby BLE tags 930, 932 and excludes the operator 900 from being identified as a pedestrian. The cap lamp system 200 deactivates transmission of its beacon so that the VCAS no longer detects the operator 900. In this implementation as shown in FIG. 9A, the cap lamp system 200 may turn on a light (e.g., a blue light or a light of any other color). In one specific implementation, the cap lamp system 200 only deactivates transmission of its beacon when it detects both BLE tags 930, 932. In a variant, transmission of the beacon can be deactivated in response to detecting only one of the two BLE tags 930, 932. In one specific implementation, a door sensor is provided in or near the door to detect whether the door 920 is open or closed. If the door is closed, in one implementation, the BLE tag 930 is activated. In another implementation, the cap lamp system only deactivates transmission of its beacon if the BLE tag 930 is detected and the door sensor indicates that the door is closed. Any other suitable logical combination of the door state (determined from the door sensor) and a proximity reading (from the BLE tag 930) may be used to infer the location of the operator and thus whether to deactivate the beacon being emitted by the cap lamp system.

As shown in FIG. 9B, the operator 900 is considered checked-in as an operator (driver) of the vehicle. Being checked-in, or associated with the vehicle, means that the cap lamp ceases broadcasting its beacon, rendering the cap lamp system and its wearer invisible to the vehicle thereby excluding the occupant/operator 900 from being identified as a pedestrian by the VCAS. Optionally, the cap lamp system 200 may receive an operator-specific code from the BLE tag(s) 930, 932 recognizable by the cap lamp system 200. In a variant, the cap lamp system 200 is an operator-specific cap lamp system configured to recognize the operator-specific code. The operator-specific cap lamp system may generate an authentication code in response to detecting the operator-specific code. The cap lamp system 200 may optionally transmit the authentication code to the VCAS of the vehicle to authorize the operator 900 to operate the vehicle based on a stored record of authorized drivers that is stored in a memory of the vehicle. The authentication code may be transmitted by the cap lamp system as part of the beacon. Alternatively, the authentication code may be transmitted by the cap lamp system a separate signal transmitted by a separate signal-transmitting device in the cap lamp system. As depicted in FIG. 9C, when the operator (person) 900 exits the cabin 910 of the vehicle, the cap lamp system 200 loses the BLE signal(s) from the BLE tag(s), i.e., the cap lamp system 200 no longer senses the proximity of the one or more BLE tags. In one specific implementation, when the BLE signal(s) from the BLE tag(s) drop(s) below a predetermined threshold of received signal strength, the cap lamp system 200 reactivates transmission of its beacon so that the VCAS resumes tracking of the person 900 as a pedestrian.

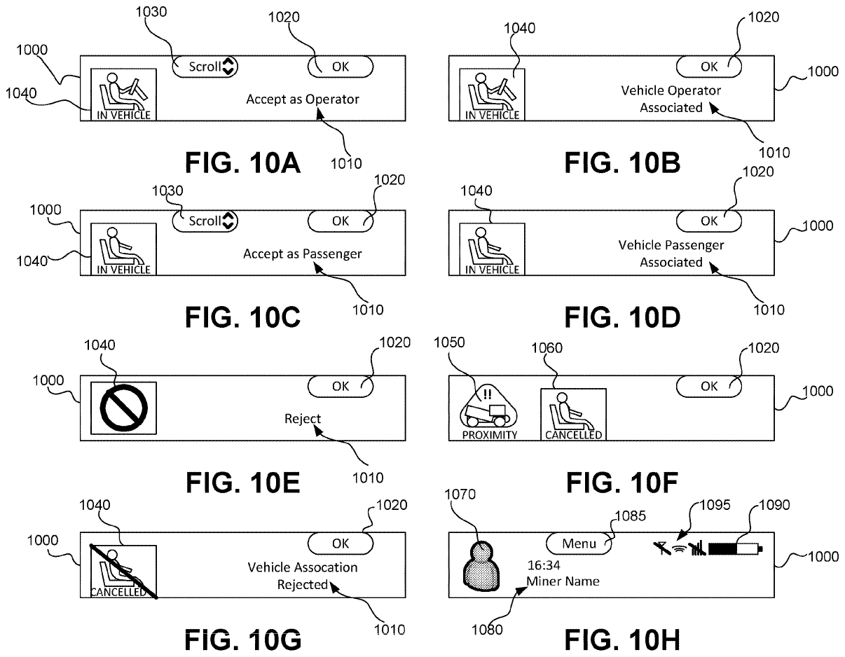

In the embodiments depicted by way of example in FIGS. 10A-10H, the belt pack of the cap lamp system 200 includes a user interface 1000, e.g., a display screen. Alternatively, the display screen may be a separate display screen that is separate from the belt pack. Alternatively, a wireless device or mobile device carried or used by the miner may be used as the display screen for the cap lamp system. The cap lamp system 200 may be paired with, or communicate with, a mobile device like a smart phone using any suitable wired or wireless protocol such as Bluetooth®. As depicted by way of example in FIG. 10A, the user interface 1000 is a display screen on a belt pack of the cap lamp system 200. The display screen may be a touchscreen or touch-sensitive display. However, any other suitable user input device may be used to enable the person to provide user input to the cap lamp system. In the example of FIG. 10A, the person (miner) is an operator of the vehicle. The user interface 1000 displays a message 1010 asking the operator to accept an association with the vehicle. The operator accepts the association by selecting an OK button 1020. As depicted by way of example in FIG. 10A, the user interface 1000 may include a scroll button 1030 to access a menu of other options, commands, or settings. As depicted by way of example in FIG. 10A, the user interface may display a status icon 1040 indicating that the cap lamp system has detected the operator inside the cabin of the vehicle. In this example, an operator icon (with a showing a person with a steering wheel) represents an operator. Optionally, a textual status (“In Vehicle”) may be displayed, e.g., below or beside the status icon.

FIG. 10B shows, in another example, the user interface 1000 confirming that the operator has been associated with the vehicle, e.g., in response to the operator accepting an association with the vehicle. The user interface displays, in this example, a message 1010 to confirm the association with the vehicle (e.g., “Vehicle Operator Associated”). This confirms that the occupant has been excluded from being identified as a pedestrian.

FIG. 10C depicts another example of a user interface 1000 prompting a passenger to accept association with a vehicle. As shown in FIG. 10C, the user interface displays a message 1010 to ask the passenger to accept association as a passenger of the vehicle. The user interface of FIG. 10C further displays an OK button 1020 to accept the association. The scroll button 1030, as described above, may also be displayed along with the status icon 1040 described above.

FIG. 10D depicts another example of a user interface 1000 confirming that the passenger has been associated with the vehicle. In this example the user interface 1000 of FIG. 10D displays a message 1010 confirming the association with the vehicle (e.g., “Vehicle Passenger Associated”). Optionally, an OK button 1020 may be displayed. The user interface may also display the status icon 1040.

FIG. 10E depicts another example of a user interface 1000 to enable the operator, passenger, or other person to reject association with the vehicle. In this example the user interface displays a message 1010 (e.g., “Reject”), an OK button 1020, and a status icon 1040.

FIG. 10F depicts another example of a user interface 1000 presenting a proximity warning that the person (operator or passenger) is too close to another vehicle. For context, in the scenario of FIG. 10F, the person is detected as being too close to both a first vehicle and a second vehicle creating ambiguity as to which of the first and second vehicles the person is inside. In such a case, out of caution, the cap lamp system precludes association in this example. The user interface 1000 displays a proximity warning icon 1050 and a cancelled icon 1060 to show the person wearing the cap lamp system that the association has been cancelled due to ambiguous proximity to multiple vehicles.

FIG. 10G depicts another example of a user interface 1000 showing that a vehicle association has been rejected. For example, the status icon 1040 may be displayed as a cancelled icon as shown to inform the person that the association has been cancelled. A message 1010 (e.g., “Vehicle Association Rejected”) may be displayed. Optionally, an OK button 1020 may be presented on the user interface.

FIG. 10H depicts another example of a user interface 1000 presenting a main screen that presents a miner photo 1070 (or alternatively an image, representation, avatar or equivalent) along with a miner name 1080. Other identifying information may be displayed such as a job title, employee number, badge number, rank, company name, etc. The user interface 1000 may display a menu button 1085 to access a menu of options, settings, commands, or other screens, a battery status 1090, for example as a battery icon visually showing an amount of charge. The user interface may also present the status (e.g., on/off) of various wireless subsystems. Various wireless status icons 1095 may be displayed as shown by way of example.

From the foregoing, it is understood that the embodiments solve a technical problem that vehicle collision avoidance systems may falsely detect a miner wearing a beacon-emitting cap lamp system and may thus treat the miner as an at-risk pedestrian even if the miner is safely inside the vehicle and is therefore actually not at risk. A false positive detection event can result in an unwanted intervention by the vehicle, e.g., emergency stop or slowing down the vehicle. The embodiments described herein solve this problem by detecting when a miner is safely inside a vehicle. In some embodiments, this can be accomplished using a cap lamp system that detects a short-range beacon emitted by a tag or other such device inside the vehicle. In some embodiments, when a person is in proximity to a low-power beacon-emitting tag inside the vehicle, the cap lamp system shuts off its own beacon-emitting device so that the VCAS no longer detects the beacon and no longer gives rises to false positive detection events while the miner is inside the vehicle. The cap lamp system thus provides a vehicle occupant exclusion technique that eliminates or at least greatly reduces false positive detection events. When the person is detected inside the vehicle, the person is considered to be checked into the vehicle or associated with the vehicle. As described above, check-in may be fully automated or partially automated or manual. Fully automated check-in associates the passenger without any passenger input. Partially automated check-in means that manual confirmation from the passenger is required to confirm the association with the vehicle. Manual check-in requires the passenger to manually initiate association. Likewise, when a passenger exits the vehicle, check-out or dissociation may be fully automated or partially automated or manual. Automated check-out requires no input or confirmation from the passenger. Partially automated check-out requires manual confirmation from the passenger to confirm that the passenger has exited from the vehicle. Manual check-out requires the passenger to initiate dissociation. Once checked out, the cap lamp system resumes broadcasting (emitting) its beacon so that any nearby VCAS will resume detection of the beacon being emitted from the cap lamp system.

Although the above description refers primarily to a mining vehicle and a miner, the embodiments may be applied and/or adapted to other types of vehicles and persons. For example, embodiments may be applied or adapted to construction vehicles and construction workers, industrial vehicles and factory workers, military vehicles and military personnel, or other analogous cases.

These methods, or portions or aspects of the methods, can be implemented in hardware, software, firmware or as any suitable combination thereof. That is, if implemented as software, the computer-readable medium comprises instructions in code which when loaded into memory and executed on a processor of a computing device causes the computing device to perform any of the foregoing method steps. The computing device may be part of a vehicle, vehicle system, cap lamp, belt pack, or cap lamp system as the case may be.

These method steps may be implemented as software, i.e., as coded instructions stored on a computer readable medium which performs the foregoing steps when the computer readable medium is loaded into memory and executed by the microprocessor of the computing device. A computer readable medium can be any means that contain, store, communicate, propagate, or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc. For the purposes of this specification, the expression “module” is used expansively to mean any software, hardware, firmware, or combination thereof that performs a particular task, operation, function or a plurality of related tasks, operations or functions. When used in the context of software, the module may be a complete (standalone) piece of software, a software component, or a part of software having one or more routines or a subset of code that performs a discrete task, operation or function or a plurality or related tasks, operations, or functions. Software modules have program code (machine-readable code) that may be stored in one or more memories on one or more discrete computing devices. The software modules may be executed by the same processor or by discrete processors of the same or different computing devices.

Computer readable program instructions can be downloaded to respective computing devices from a computer readable storage medium or to an external computer or external storage device via a data network, for example, the Internet, a local area network, a wide area network or a wireless network. The network may comprise copper transmission cables, optical transmission fibers, wireless transmission, routers, firewalls, switches, gateway computers and/or edge servers. A network adapter card or network interface controller (NIC) in each computing device receives computer readable program instructions from the network and transmits the computer readable program instructions for storage in a computer readable storage medium within the respective computing device.

Computer readable program instructions are computer-executable instructions in machine-readable code for carrying out operations of the present embodiments and may be assembler instructions, instruction-set-architecture (ISA) instructions, machine instructions, microcode, firmware instructions, state-setting data, configuration data for integrated circuitry, or either source code or object code written in any combination of one or more programming languages, including an object oriented programming language and procedural programming languages. The computer-executable instructions executed by a computing device carry out program processes such as routines, programs, objects, components, logic, data structures that perform particular tasks or implement particular abstract data types.

Various aspects and embodiments are described with reference to flowcharts and/or block diagrams of methods, systems, and computer program products. Each block of the flowcharts and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified by a block of the flowchart and/or block diagram.

The computer readable program instructions may also be loaded onto a computer, other programmable data processing apparatus, or other device to cause a series of operational steps to be performed on the computer, other programmable apparatus or other device to produce a computer implemented process or computer-implemented method, such that the instructions which execute on the computer, other programmable apparatus, or other device implement the functions/acts specified in the flowchart and/or block diagram.

The flowchart and block diagrams in the figures illustrate the architecture, functionality, and operation of possible implementations of systems, methods, and computer program products according to various embodiments. Each block in the flowchart or block diagrams may represent a module, segment, or portion of instructions, which comprises one or more executable instructions for implementing the specified function. In some alternative implementations, the functions noted in the blocks may occur out of the order shown in the figures. For example, two blocks shown in succession may be executed substantially concurrently, or the blocks may sometimes be executed in the reverse order, depending upon the functionality involved. Each block of the block diagrams and/or flowcharts, and combinations of these blocks, can be implemented by special purpose hardware-based systems that perform the specified functions or acts or carry out combinations of special purpose hardware and computer instructions.

For the purposes of interpreting this specification, when referring to elements of various embodiments, the articles “a”, “an”, “the” and “said” are intended to mean that there are one or more of the elements. The terms “comprising”, “including”, “having”, “entailing” and “involving”, and verb tense variants thereof, are intended to be inclusive and open-ended by which it is meant that there may be additional elements other than the listed elements.

The above-described embodiments are examples only. Alterations, modifications, and/or variations may be effected to the particular embodiments by those skilled in the art without departing from the scope of the description.

1. A vehicle comprising:
a first sensor configured to sense a first beacon emitted by a first beacon-emitting device worn by a person, the first sensor configured to generate a first sensor signal in response to sensing the first beacon;
a collision-avoidance processor communicatively coupled to the first sensor and configured to receive the first sensor signal, wherein the collision-avoidance processor is configured to determine if the person is located in an unsafe location relative to the vehicle based, at least in part, on the first signal, wherein the collision-avoidance processor is further configured to control the vehicle by slowing, stopping or steering the vehicle in response to determining that the person is located in the unsafe location; and
a second beacon-emitting device disposed in or near a seat in the vehicle, the second beacon-emitting device configured to emit a second beacon detectable by a second sensor worn by the person when the person sits in the seat, wherein the second beacon has lower power and less range than the first beacon, the second sensor generating a second sensor signal in response to sensing the second beacon when the person sits in the seat, the first beacon-emitting device being deactivated in response to the second sensor signal.

2. The vehicle of claim 1, wherein the first beacon-emitting device is part of a cap lamp configured to be worn by the person, and the first sensor is mounted on an external surface of the vehicle.

3. The vehicle of claim 1, wherein the second beacon-emitting device is a proximity tag, and the second sensor is part of a belt pack configured to be worn by the person.

4. The vehicle of claim 3, wherein the proximity tag is a Bluetooth® Low Energy (BLE) tag.

5. The vehicle of claim 3, comprising a plurality of seats and a plurality of proximity tags, wherein each seat has a respective proximity tag.

6. The vehicle of claim 3, comprising a plurality of seats and wherein the proximity tag includes a common leaky feeder antenna.

7. The vehicle of claim 3, comprising a plurality of proximity tags for each seat.

8. The vehicle of claim 3, wherein the collision-avoidance processor is configured to receive a confirmation signal generated by the belt pack in response to user input from the person confirming that the person is inside the vehicle.

9. The vehicle of claim 1, wherein the collision-avoidance processor is configured to detect a door switch state and a safety belt state to validate an initial determination that the person is inside or outside the vehicle.

10. The vehicle of claim 3, wherein the collision-avoidance processor is configured to detect a fault state or a low battery state in the proximity tag.

11. The vehicle of claim 3, wherein the collision-avoidance processor is configured to detect if the proximity tag has been disconnected.

12. A cap lamp system comprising:
a cap lamp configured to be worn by a person, the cap lamp having a first beacon-emitting device configured to emit a first beacon that is detectable by a first sensor of a vehicle to enable a collision-avoidance processor of the vehicle to determine if the person is located in an unsafe location relative to the vehicle; and
a belt pack configured to be worn by the person, the belt pack having a second sensor that is configured to sense a second beacon emitted by a second beacon-emitting device disposed in or near a seat of the vehicle, the second beacon having lower power and less range than the first beacon, wherein the first beacon-emitting device in the cap lamp is configured to be deactivated when the second sensor detects the second beacon thereby indicating that the person is sitting safely inside the vehicle.

13. The system of claim 12, wherein the first beacon-emitting device only resumes emitting the first beacon when the second beacon is no longer detected by the second sensor.

14. The system of claim 12, wherein the second beacon-emitting device is a Bluetooth® Low Energy (BLE) tag.

15. The system of claim 12, wherein the belt pack includes a user interface arranged to display an automatically determined status of the person, the status indicating whether the person is considered to be inside the vehicle or outside the vehicle.

16. The system of claim 15, wherein the user interface includes a user input device arranged to enable the person to manually confirm the automatically determined status.

17. The system of claim 15, wherein the user interface includes a user input device arranged to enable the person to manually identify the person as an operator of the vehicle or as a passenger of the vehicle.

18. The system of claim 12, wherein the first beacon-emitting device in the cap lamp is deactivated when the second sensor detects that a received signal strength indicator (RSSI) of the second beacon exceeds a threshold.

19. The system of claim 15, wherein one or both of the belt pack or cap lamp includes a light that turns on, blinks, or changes colour when the status of the person is automatically determined or when the person manually confirms the status.

20. A method, performed by a vehicle, comprising:
sensing a first beacon emitted by a first beacon-emitting device of a cap lamp worn by a person;
determining from the first beacon if the person is located in an unsafe location relative to the vehicle; and
emitting a second beacon by a second beacon-emitting device disposed in or near a seat of the vehicle that is detectable by a second sensor in a belt pack also worn by the person, indicating that the person is sitting inside the vehicle, wherein the first beacon-emitting device is deactivated in response to detecting the second beacon by the second sensor.

21. The method of claim 20, wherein the second beacon has lower power and less range than the first beacon, and wherein the second beacon-emitting device is a Bluetooth® Low Energy (BLE) tag.

22. The method of claim 20, further comprising displaying an automatically determined status of the person, the status indicating whether the person is considered to be inside the vehicle or outside the vehicle.

23. The method of claim 22, further comprising receiving user input from the person to manually confirm the automatically determined status.

24. The method of claim 22, further comprising receiving user input from the person to manually identify the person as an operator of the vehicle or as a passenger of the vehicle.

25. The method of claim 20, further comprising detecting a door switch state and a safety belt state to validate an initial determination that the person is inside or outside the vehicle.

26. A method, performed by a cap lamp system, comprising:
emitting a first beacon by a first beacon-emitting device of a cap lamp worn by a person, the first beacon being detectable by a first sensor of a vehicle to enable the vehicle to determine if the person is located in an unsafe location relative to the vehicle;
sensing, by a second sensor in a belt pack worn by the person, a second beacon emitted by a second beacon-emitting device disposed in or near a seat of the vehicle, indicating that the person is sitting inside the vehicle; and
deactivating the first beacon-emitting device in response to detecting the second beacon by the second sensor.

27. The method of claim 26, further comprising displaying on the belt pack an automatically determined status of the person, the status indicating whether the person is inside the vehicle or outside the vehicle.

28. The method of claim 27, further comprising receiving user input from the person to manually confirm the automatically determined status.

29. The method of claim 27, further comprising receiving user input from the person to manually identify the person as an operator of the vehicle or as a passenger of the vehicle.

30. The method of claim 26, further comprising broadcasting by the cap lamp or belt pack an identifier code identifying the person as an operator or as a passenger.

31. The method of claim 26, further comprising causing a light on one or both of the belt pack or cap lamp to turn on, blink, or change colour when the status of the person is automatically determined to be inside the vehicle or when the person manually confirms the status.

32. A method comprising:
emitting a first beacon by a first beacon-emitting device worn by a person, the first beacon being detectable by a first sensor of a vehicle to enable the vehicle to determine if the person is located in an unsafe location relative to the vehicle;
detecting by a second sensor that the person is seated in the vehicle; and
deactivating the first beacon-emitting device in response to detecting that the person is seated in the vehicle.

33. The method of claim 32, wherein the second sensor is disposed in a belt pack worn by the person.

34. The method of claim 33, wherein the second sensor detects a second beacon emitted by a second beacon-emitting device disposed in the vehicle.

35. The method of claim 34, wherein the second beacon-emitting device is a Bluetooth® Low Energy (BLE) tag.

36. The method of claim 34, wherein the second beacon-emitting device is a leaky feeder antenna.

37. The method of claim 32, wherein the first beacon-emitting device is part of a cap lamp worn by the person.
